(19) United States
(12) Patent Application Publication
(10) Pub. No.: US 2003/0152129 A1
(43) Pub. Date: Aug. 14, 2003

(54) Antimicrobial thermometer

(75) Inventor: Yongwon Lee, Kyunggi-do (KR)

Correspondence Address: STAAS & HALSEY LLP, 700 11TH STREET, NW, SUITE 500, WASHINGTON, DC, 20001, US

(73) Assignee: YUIL MEASURES CO., LTD., Paju-shi (KR)

(21) Appl. No.: 10/386,708

(22) Filed: Mar. 13, 2003

Related U.S. Application Data
(62) Division of application No. 10/112,306, filed on Apr. 1, 2002.

(30) Foreign Application Priority Data
Jul. 26, 2001 (KR) 2001-45105

(51) Int. Cl. G01K 1/00

(52) U.S. Cl. 374/55; 374/100; 374/208; 374/54

(57) ABSTRACT

The present invention relates to a cooking thermometer which can measure a temperature in contact with foodstuffs directly or around foodstuffs during the cooking process. Particularly, the present invention relates to a cooking thermometer which inhibits the proliferation of bacteria on the surface of the thermometer and is coated with an antibacterial compound such as titanium dioxide. The antibacterial thermometer of the present invention coated with titanium dioxide comprises a temperature measurement part which calculates and indicates the temperature of food during the cooking process; and a titanium dioxide coating layer which is covered onto the surface of said temperature measurement part with the antibacterial activity

### FIELD OF THE INVENTION

The present invention relates to a cooking thermometer which can measure a temperature in contact with foodstuffs directly or around foodstuffs during the cooking. Particularly, the present invention relates to a cooking thermometer which inhibits the proliferation of bacteria on the surface and is coated with titanium dioxide, an antibacterial compound.

### DESCRIPTION OF THE RELATED ART

Generally, it is very important to maintain the temperature properly during the cooking. For this purpose, the kitchen instrument equipped with the thermometer such as oven, microwave or the like has been already developed. Also, the cooking thermometer for the kitchen was commercialized as a single goods.

That is to say, the thermometer with the system illustrated in FIG. 4 has been utilized to measure the internal temperature of food elaborately while meat such as steak, hamburger, beef, pork and so on, fowls such as chicken, turkey, duck and so on and fishes such as salmon, sea bass and so on were cooked by using charcoal fire, fly pan and the like. Namely, the principle is that the thermometer (10) with a long heat sensing part like a nail is put deeply into foodstuffs (24) so as to measure the internal temperature. Concretely, the thermometer can calculate the temperature of meat lump exactly in the middle region since the thermometer has a temperature sensor in the end of the heat sensing part as exemplified in FIG. 4. In this process, the internal state of foodstuffs is estimated and thus the cooking time and the heating power is determined. Precisely, raw meat lump can be sterilized by the surface temperature (about more than 140° F.) during the cooking, since bacteria exist only on the surface of meat. However, if the meat lump is minced like hamburger, bacteria could survive at the inside. Therefore, heat should be transferred into the center for killing bacteria existed internally. Especially, the processed foodstuffs requires to calculate the internal temperature during the cooking.

Hence, the cooking thermometer is necessary to get in touch with foodstuffs directly for measuring its temperature. In addition, the thermometer should be washed after its use to eliminate food leftovers, for example condiments, food scraps, water and so on. However, the process for cleaning the thermometer is troublesome and especially in meat food, needs to spend much time and efforts since oil is also remained onto the surface of the thermometer. Furthermore, such a process cannot be neglected or overlooked because a number of bacteria are possible to grow onto the thermometer (for example, 0-157 bacterium attached to hamburger meat). These bacteria have caused various diseases such as bromatoxism and allergy, when transfected to food again.

On the other hand, the cooking thermometer is essential to store foodstuffs or food material requiring refrigeration and freezing in practice, but it is difficult to be managed and treated hygienically.

As demonstrated above, the thermometer should be applied for cooking foods, storing foodstuffs or the like and facilitates these procedures of cooking. Unfortunately, the conventional thermometer causes some problems in practice because it is hard to be treated hygienically.

Therefore, the inventors of the present invention have tried to develop a novel cooking thermometer for solving these disadvantages.

### SUMMARY OF THE INVENTION

The object of the present invention is to provide a cooking thermometer which inhibits the proliferation of bacteria and has an antibacterial effect, since titanium dioxide (TiO₂) is coated onto the surface of the thermometer.

### BRIEF DESCRIPTION OF THE DRAWINGS

The above and other objects, features and other advantages of the present invention will be more clearly understood from the following detailed description taken in conjunction with the accompanying drawings, in which;

FIG. 1 represents a front view of an internal structure of the antibacterial thermometer coated with titanium dioxide in the first example of the present invention.

FIG. 2. represents a planar view of the thermometer described in FIG. 1.

FIG. 3 represents a magnified cross-sectional view of a sensing pinnacle part (A) described in FIG. 1.

FIG. 4 represents a use state of the antibacterial thermometer coated with titanium dioxide in the present invention.

FIG. 5 represents a front view of an internal structure of the antibacterial thermometer coated with titanium dioxide in the second example of the present invention.

FIG. 6. represents a planar view of the thermometer described in FIG. 5.

FIG. 7 represents a block diagram of the internal circuit for the thermometer described in FIG. 5.

FIG. 8 represents a front view of an internal structure of the antibacterial thermometer coated with titanium dioxide in the third example of the present invention.

FIG. 9 represents a rear view of the head in the thermometer described in FIG. 8.

FIG. 10 represents a front view of an internal structure of the antibacterial thermometer coated with titanium dioxide in the fourth example of the present invention.

FIG. 11 represents a front view of an internal structure of the antibacterial thermometer coated with titanium dioxide in the fifth example of the present invention.

### Explanation of Symbols in the Figures

6: coating layer

10: thermometer

11: wire

12: head

14: bolt

16: heat sensing part

18: expanded spring

20: needle

22: graduations

24: foodstuffs

40: electric power case

### DETAILED DESCRIPTION OF PREFERRED EMBODIMENTS

In order to accomplish the object, the present invention provides an antibacterial thermometer coated with titanium dioxide. The antibacterial thermometer comprises a temperature measurement device which calculates and indicates the temperature of foodstuffs during the cooking; and a titanium dioxide coating layer (6) which covers the surface of the temperature measurement device with an antibacterial activity.

In the first example of the thermometer (10) in the present invention, the temperature measurement device is a plug which comprises an expanded spring (18) deformed in a twist mode in proportion to temperature; a wire (11) with a proper length in which one end is fixed onto one end of the expanded spring (18) passing through the axial line of the expanded spring (18) and a middle region is fixed onto the other end of the expanded spring (18); and a sensing pinnacle part (A) in one end. In addition to the temperature measurement device, the present invention provides the thermometer which comprises a coating layer of heat sensing part (6) with a proper length in which one end of the expanded spring (18) and one end of the wire (11) are fixed to the interior of the sensing pinnacle part (A) together; a needle (20) which is formed in the other end of the heat sensing part (6), is connected to the other end of the wire (11) and can rotate in proportion to the deformation of the wire (11); and a head (12) in which the wire (11) passing through the center and temperature graduations are indicated to correspond to rotational angles of the needle (20).

In the second example of the thermometer (50) in the present invention, the temperature measurement device can include a temperature sensor (37) which accepts an output electric signal varied in proportion to temperatures; a heat sensing part (36) in which the temperature sensor (37) is fixed to the inside and one end has the heat sensing part (36) with a pinnacle passing through foodstuffs with a proper length; and a microprocessor (42) and a display (39) which indicate and transform electric signals accepted from the temperature sensor (37) to digital numbers. Depending upon requirements, the temperature measurement device can include an electric wire (33, 34) connecting the temperature sensor (37) and the microprocessor (42) electrically; an electric power part (43) providing electric power for the temperature sensor (37), the microprocessor (42) and the display (39); and a button part (41) transmitting on/off switching signals to the microprocessor (42) additionally. Besides, the electric power part (43) can include a battery and an electric power case (40) in which the battery is put on and taken off possibly.

In the third example of the thermometer (70) in the present invention, the temperature measurement device comprises a head (60) indicted with temperature graduations (52) on one side; a rotatable needle (54) connected with the central axis (66) of the head (60); a spiral spring (62) deformed in accordance with temperature since one end is fixed onto the rear surface of the head (60) and the other end is fixed onto the rotational axis (66) of the needle (54); and a fixation device for fixing the head (60). Preferably, the fixation device is a shelf (56) which is fixed on the lower part of the head (60) and supports the head (60) or a hanger (58) formed for hanging the thermometer (50) on the upper part of the head (60).

In the fourth example of the thermometer (70) in the present invention, the temperature measurement device comprises a heat sensing part (72) containing a liquid expanding the volume in accordance with temperatures; a measurement part (74) which makes one body with the heat sensing part (72), has a pathway in the inside for moving the liquid and contains graduations corresponding to the expansion of the liquid.

In the fifth example of the thermometer (70) in the present invention, preferably the thermometer (70) is fixed on one surface of a base plate (88). The base plate (88) also comprises a cover (86) covering the heat sensing part (72) of the thermometer (70); temperature graduations (84) indicated across the thermometer (70); and a handle (82) formed on the upper part, and the base plate (88) includes an elastic clip (83) which is fixed and inserted to a cooking container in a standing state.

In the present invention, the surface of the antibacterial thermometer can be made of any material if the material is innoxious for human body and chemically stable both in the high temperature and the low temperature. Preferably, the material used for the surface of the thermometer is aluminum, stainless steel or the like.

In the antibacterial thermometer of the present invention, titanium dioxide can be coated to form the titanium dioxide coating layer by using various methods known previously. Precisely, the thermometer can be treated by the process as follows, in which the thermometer is soaked into titanium dioxide sol repeatedly, is sprayed with titanium dioxide sol several times and is coated with titanium dioxide sol by using a brush and the like.

In detail, the thermometer is soaked into the solution of titanium dioxide sol 1˜5 times repeatedly to form a coating layer. Also, the thermometer with a photo-catalyst coating layer can be obtained by the process comprising the steps: covering 1˜5 times repeatedly by using a spraying apparatus; and heating and plasting for a proper time period at about normal temperatur ˜752° F., depending upon the property of titanium dioxide sol. At that time, the time of the immersion or the time of spraying is controlled properly in accordance with the thickness of the coating layer required. Preferably, the thickness of the coating layer is at the range of about 0.05˜1.0 μm in accordance with the number of covering.

Another purposes, particular advantages, further features of the present invention will appear clearly hereinafter.

The examples of the present invention will be illustrated clearly referring to the accompanying drawings hereinafter.

Before describing accompanying drawings, the antibacterial function of titanium dioxide (TiO₂) will be explained. The photo-catalyst is a substance which generates activated oxygen molecules with a high activity by irradiating and thus accelerates a chemical reaction, namely degradation. Concretely, as a photo-catalyst, titanium dioxide (TiO₂), zinc oxide (ZnO), tin dioxide (SnO₂) and the like can be selected and especially, titanium dioxide is known widely since it is very resistant to acids and alkalis and is harmless for human body. The titanium dioxide has been utilized as a photo-catalyst and generates activated oxygens when light touches and the produced oxygen has the high decomposition activity. Such a decomposition activity plays a role to degrade organic material, to kill bacteria, to remove malodor, to eliminate toxic substance and the like. Then, titanium dioxide can be exploited semi-permanently and is very hard characteristically due to the property of photo-catalyst.

In addition, the antibacterial thermometer of the present invention which uses such a titanium dioxide will be disclosed hereinafter.

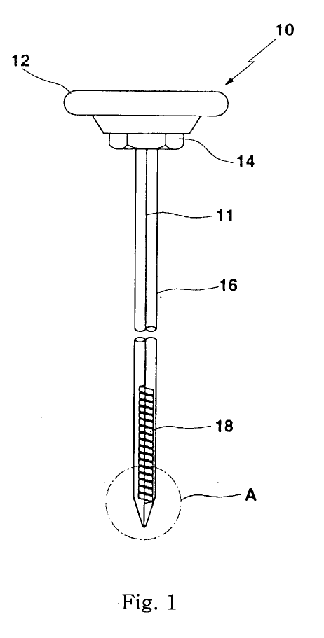

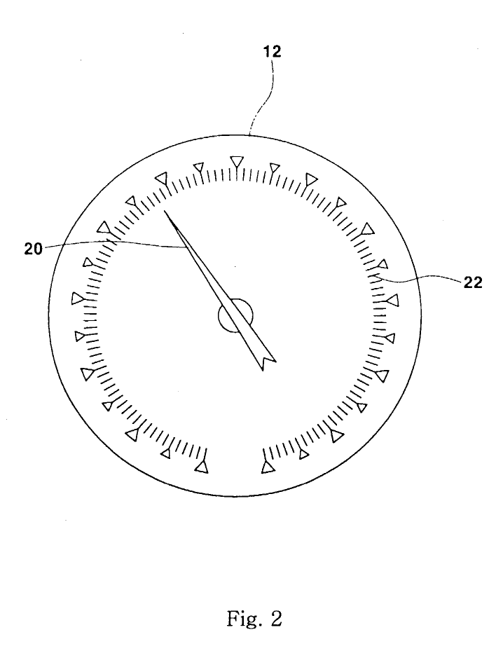

FIG. 1 depicts a front view of an internal structure of the antibacterial thermometer coated with titanium dioxide in the present invention. FIG. 2. depicts a planar view of the thermometer (10) described in FIG. 1.

As illustrated in FIG. 1 and FIG. 2, the outer appearance of the thermometer (10) is mainly composed of a head (12) and a heat sensing part (16). The head (12) has an analog form and is equipped with a needle (20) and graduations (22) indicating temperature and the heat sensing part (16) is equipped with an expanded spring (18) and a wire (11) in the inside.

One end of the wire (11) is fixed onto a sensing pinnacle part (A) and the other end is fixed onto the needle (20) of the head (12). As a result, when the wire (11) is deformed in a twist mode, the needle (20) rotates coincidently and indicates graduations (22) of the head (12). The graduations (22) can be illustrated in ° C. unit and/or ° F. unit, depending upon occasions.

The sensing pinnacle part (A) has a sharp terminus and is easy to pierce through foodstuffs and its inside is equipped with the expanded spring (18).

The heat sensing part (16) and the head (12) is adjoined with a bonding means such as bolt (14). The thermometer is preferable to be made of stainless steel wholly, which makes the thermometer endure the heat well and resist the corrosion.

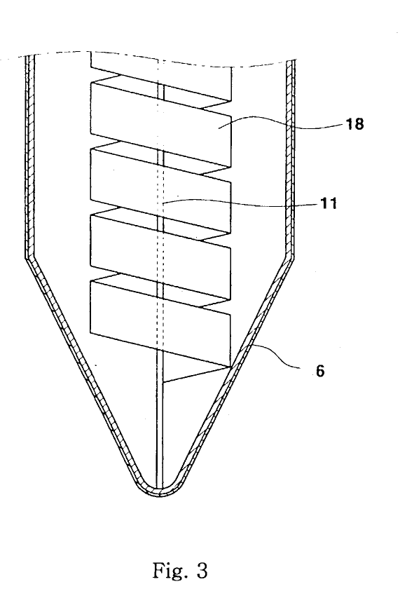

FIG. 3 depicts a magnified cross-sectional view of the sensing pinnacle part (A) described in FIG. 1. As illustrated in FIG. 3, the expanded spring (18) is made of a bimetal band by attaching different kinds of metals and processing spirally. Thus, one end is associated to the inside of the sensing pinnacle part (A) with the wire (11) by welding and the like and the other end is fixed to the middle region of the wire (11).

The heat sensing part (16) and the head (12) have a titanium dioxide coating layer (6) formed onto the surfaces homogenously. This coating layer (6) has a uniform thickness, even if thin, around the entire surface of the thermometer (10).

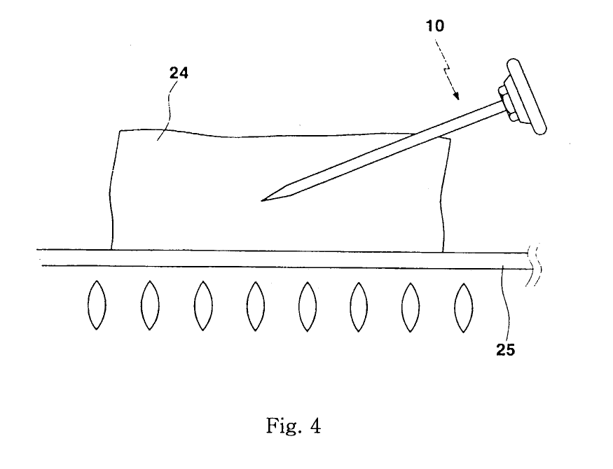

FIG. 4 depicts a use state of the antibacterial thermometer coated with titanium dioxide in the present invention. The present invention will be illustrated precisely, referring to FIG. 4. As described in FIG. 4, since foodstuffs (24) (for example, meat lump for steak) placed on the cooking vessel (25) usually takes heat from the bottom, the inside is not still cooked although the outside appears well done.

Therefore, the sensing pinnacle part (A) penetrates the foodstuffs (24) deeply so as to be fixed onto the inside. Then, the temperature of the foodstuffs (24) is transferred to the heat sensing part (16) and provokes the expansion with twists of the expanded spring (18). Since this expanded spring (18) is fixed onto two points of the wire (11), the wire (11) passing through the center of the expanded spring (18) is also deformed in a twist mode proportionally. As a result, the needle (20) within the head (12) is to rotate.

In this process, cookers can detect the temperature of foodstuffs (24) in the center comfortably. However, the surface of the thermometer (10) is liable to be adhered by condiments, meat juice, oils and the like when the thermometer is drawn out of the foodstuffs (24) and then bacteria is infected and proliferates easily. The thermometer of the present invention can degrade these remainders by exploiting the photo-catalysis reaction when light is emitted onto the thermometer as explained above. Therefore, the thermometer has a function to remove malodors, to resist to bacteria and to kill bacteria. Meanwhile, the thermometer is not required to be irradiated all the time for the photo-catalyst reaction since the reaction can be processed after the irradiation.

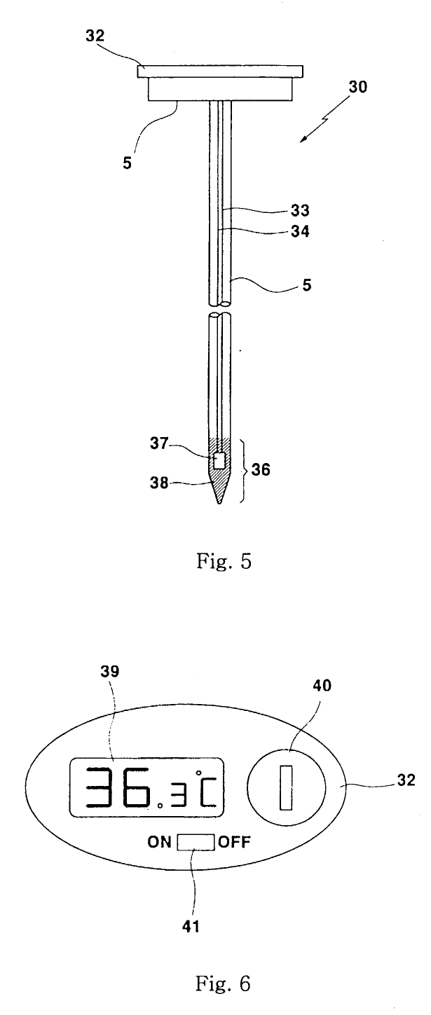

FIG. 5 depicts a front view of an internal structure of the antibacterial thermometer coated with titanium dioxide in the second example of the present invention. FIG. 6. depicts a planar view of the thermometer (10) described in FIG. 5.

As illustrated in FIG. 5 and FIG. 6, the outer shape of the thermometer (30) is composed of the head (32) and the heat sensing part (36) largely. Again, the head (38) is equipped with the display (39) indicating the temperature in a digital form, the button (41) and the electric power case (40). Then the heat sensing part (36) is equipped with the temperature sensor (37) internally and with epoxy resins (38) as a bonding material.

The temperature sensor (37) is a small-sized semiconductor sensor which changes the electric property in accordance with the temperature. The first electric line (33) is to input the standard voltage toward the temperature sensor (37). Precisely, one end is connected to the output terminus (not depicted) of electric signals in the microprocessor (42) and the other end is sent to the temperature sensor (37). The second electric line (34) is to transmit changed electric signals for the microprocessor (42). Concretely, one end is connected to the temperature sensor (37) and the other end is sent to the input terminus (not depicted) of electric signals in the microprocessor (42).

In the case that an air layer exists in between the temperature sensor (37) and the heat sensing part (36), the temperature is difficult to be calculated exactly. Therefore, the bonding material with high heat transmissibility, such as epoxy resins (38), is utilized to fix the temperature sensor (37) and the part of the electric line (33, 34) onto the inside of the heat sensing part (36) tightly. The epoxy resins (38) is a liquid during the use and become a hard solid after a proper period. Hence, the epoxy resin (38) can fix the temperature sensor (37) as an adhesive agent to prevent it from wavering internally.

In the case that the output electric signal of the temperature sensor (37) is changed in accordance with the temperature variation, the microprocessor (42) takes the signal, determines the value of temperature against the electric signal and transmits the value to the indication part such as LCD display (39). As a result, the display can depict the numbers, for example “90.5° F.”. The temperature is designated with ° C. unit or ° F. unit selectively through the operation of buttons.

The heat sensing part (36) is made to pierce foodstuffs easily, since the terminus is very sharp.

Preferably, the heat sensing part (36) and the head (32) is manufactured by using stainless steel and thus is liable to resist to heat and hard to be eroded.

The head (32) is equipped with the display (39) in which the temperature is designated with numbers and is output. The electric power case (40) which can rotate for the closure and the open in a spiral mode. The electric power case (40) includes a miniature battery and can be replaced by opening if the battery finishes its life. This electric power case (40) is composed of plastic material and protects the penetration of water by using O-ring made of rubber substance.

The button (41) generates a switching signal for the operation of on/off. Precisely, if it is pressed long in the off state, the temperature units (° C. or ° F.) are switched and if it is pressed long in the ‘on’ state, the hold function is operated not to change the present temperature indicated. The button (41) can detect the variation of ‘on/off’ by protruding the switch region onto the membrane plate (not depicted).

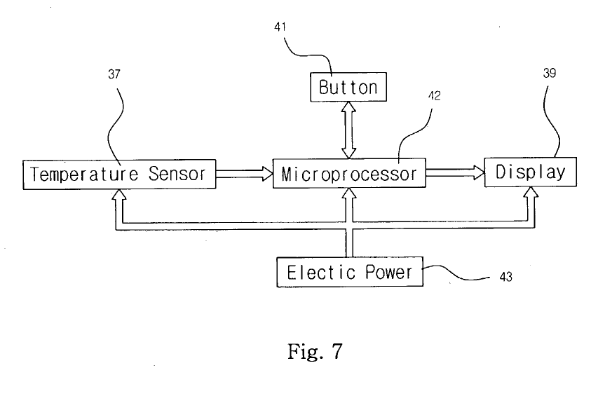

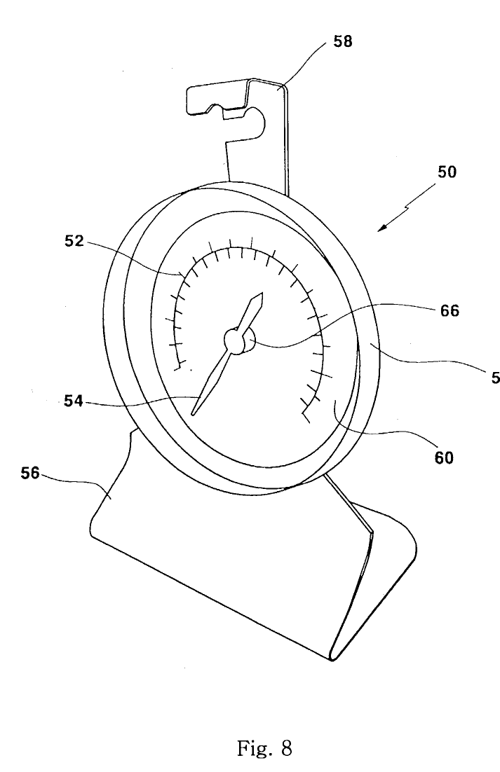

FIG. 7 depicts a block diagram of the internal circuit for the thermometer described in FIG. 5. The temperature sensor (37) sends electric signal outputs to the microprocessor (42) in proportion to the temperature. The microprocessor (42) receives a necessary operation command through the button (41) and includes the working circuit operating the display (39). For the electric power (43), a miniature battery is utilized and the required electric power is provided for the temperature sensor (37), the microprocessor (42) and the display (39).

FIG. 8 depicts an internal structure of the antibacterial thermometer coated with titanium dioxide in the third example of the present invention. As illustrated in FIG. 8, the thermometer (50) can be stood by using the shelf (56) and be hanged to nails and so on by using the hanger (58). If necessary, a permanent magnet can be attached to fix the thermometer onto the wall. The thermometer (50) reads the graduations (52) in naked eyes in accordance with the rotation of the needle (54) and is equipped with transparent glass or a plastic window in front of the needle (54).

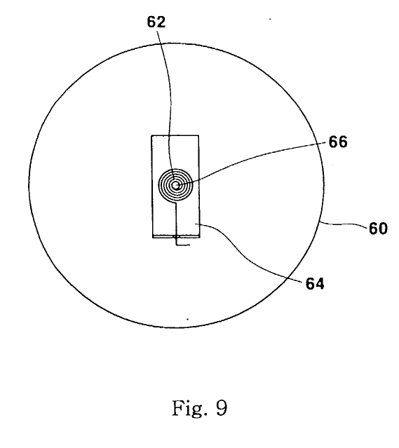

FIG. 9 depicts a rear view of the head (60) in the thermometer described in FIG. 8. As illustrated in FIG. 9, the rear surface of the head (60) includes the spiral spring (62) which changes the shape according to the temperature. One end of the spiral spring (62) is curved in a “L” form and inserted onto the fixing plate (64). Then, the other end is connected to the rotational axis (66) of the needle (54).

The spiral spring (62) is adjoined with other kinds of metals which have different heat expansion coefficients. When the spiral spring (62) expands in the high temperature, the radius has a tendency to increase and when it shrinks in the low temperature, the radius has a tendency to decrease. The variation of the radius is transferred to provoke the rotation of the needle (54) in the other end.

The entire surface of the antibacterial thermometer (50) is covered with the titanium dioxide coating layer (6), even if thin, in a uniform thickness. The thermometer (50) is preferable to be placed in the bottom of the oven (not depicted) or the refrigerator (not depicted), or hanged on the wall for uses. In order to measure the temperature precisely, the thermometer (50) should be placed to foodstuffs as near as possible. In addition, although remainders such as condiments, soot, oils, water, meat juice and the like are splashed to stain the thermometer from the foodstuffs during cooking, the coating layer (6) kills bacteria and removes other dirts by operating the photo-catalysis.

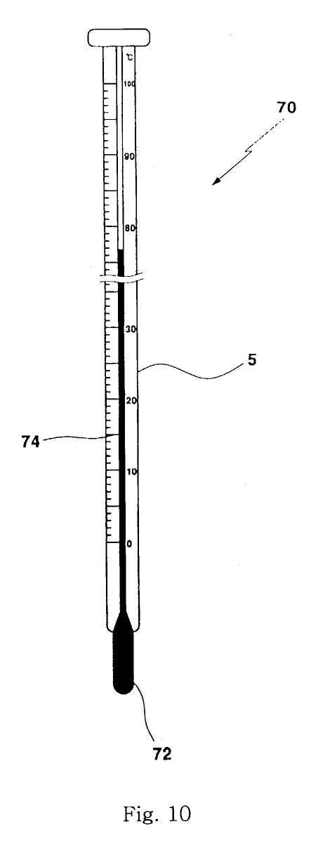

FIG. 10 depicts a front view of an internal structure of the antibacterial thermometer coated with titanium dioxide in the fourth example of the present invention. As illustrated in FIG. 10, the thermometer comprises the heat sensing part (72) containing a liquid expanding volumes according to temperatures and the measurement part (5) in a plug shape pierced to pass the liquid. The liquid expands the volume in accordance with the increase of temperatures and increases the height while forms a plug, since the liquid is adopted from transparent or pigmented (for example, blue, red and so on) petroleum, alcohol, mercury and the like. In order to calculate the increase of the height, the measurement part (5) is indicated with graduations (74) of the uniform interval on one side. These graduations (74) can be depicted with ° C. unit and/or ° F. unit. Then, the entire surface of the thermometer (70) is covered with titanium dioxide coating layer (6) which is thin and smooth.

As demonstrated above, the thermometer (70) coated with titanium dioxide can be applied for the perpendicular type as illustrated FIG. 10 as well as the horizontal type (not depicted). Precisely, the horizontal type thermometer can be hanged or stood in the interiors of the cold room and the freezing room existed in the refrigerator (not depicted).

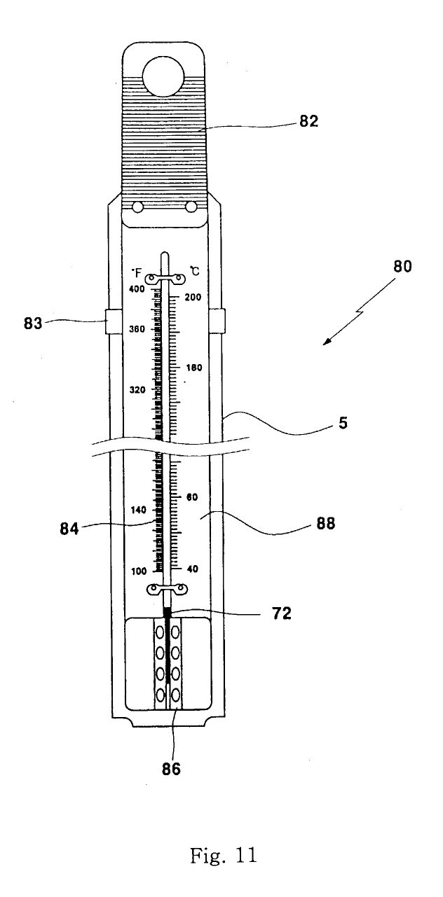

FIG. 11 depicts a front view of an internal structure of the antibacterial thermometer coated with titanium dioxide in the fifth example of the present invention. As illustrated in FIG. 11, one side of the thermometer (80) is to fix the base plate (88) prepared with stainless steel. The heat sensing part (86) is protected by the fragment of the base plate (88) which is cut and rounded circularly and is indicated with constant graduations (84) according to the glass thermometer (80). As shown in FIG. 11, the right side of the thermometer includes the graduation indicted with ° C. unit and the left side of the thermometer includes the graduation indicated with ° F. unit.

The upper surface of the base plate (88) is equipped with the handle (82) made of plastic substance. Such a plastic handle (82) can prevent the transmission of heat and makes the hot thermometer treated easily. Particularly, the surface of the handle (82) forms a concave which prevents slips by oils and the like.

The clip (83) is equipped to the rear surface of the base plate (88) and has a shape of pen clip. This clip (83) can be fixed onto the cooking vessel (for example, fry pan) and the like easily since it is made of elastic stainless steel. The entire surfaces of the thermometer (80), the base plate (88) and the clip (83) are coated with the titanium dioxide coating layer which has a thin and uniform thickness. The fifth example of the thermometer is utilized to measure the temperatures when it is soaked partly into the liquid (water, bean oil, soup and the like) during heating.

Practical and presently best modes of the present invention are illustrative as shown in the following Preferred Embodiments.

However, it will be appreciated that those skilled in the art, on consideration of this disclosure, may make modifications and improvements within the spirit and scope of the present invention.

Concretely, in examples of the present invention, titanium dioxide coating material is purchased from the specified company and the coating process is accomplished in accordance with the product manual from the above company. It is clear to those skilled in the art that any product and any coating method can be applied for the coating process of the thermometer.

The present invention has utilized titanium dioxide (TiO₂) as an oxygenated titanium, but is not limited by the use. It is natural that the other oxygenated titanium system compound for the sterilization or its equivalent compounds can be adopted.

<Preferred Embodiment> Preparation of the Antibacterial Thermometer Coated With Titanium Dioxide and Measurement of the Antibacterial Activity

(1) The heat sensing part used in the experiment had 15.75 inches of length and 1 cm of diameter, included the head with 5 inches of diameter and was composed of stainless steel. The cooking thermometer for the kitchen which can measure the temperature at the range of −5˜1000° F. was sprayed by using 2% and 4% of titanium dioxide sol for coating at the normal temperature (Product name: SLOST-250A(Z); purchased from E & B KOREA Co., Ltd.). Then, the thermometer was dried repeatedly twice at room temperature. As a result, the antibacterial thermometer of the present invention was manufactured to be coated with 2% and 4% of titanium dioxide.

(2) The film attachment method (FC-TM-20)-2001 was applied to elucidate the antibacterial activity of the thermometer prepared above (Experimental organization: Korean FITI Testing & Research Institute) experimentally. In each thermometer, the surface size was adjusted to become 25 cm² and cut for the samples. In the process for obtaining the samples, it was confirmed that the antibacterial activity of the sample and the antibacterial activity of the thermometer is the same naturally, since any chemical reactions were provoked.

The bacterial strain was selected from Escherichia coli ATCC 25922 and Staphylococcus aureus ATCC 6538 and the like and inoculated for the measurement. The standard covering film was STOMACHER 400 POLY-BAG and then used for the experiment.

The strain was cultivated with nutrient medium (Bacto-Peptone 5 g, beef extract 3 g, distilled water 1 L) for 24 hours and then controlled to adjust the concentration of bacterial cells for the inoculation by mixing new nutrient medium. The sample (a cutting fragment of the thermometer) was not absorbing water and thus as a non-ionic detergent Tween 80 was added to make the inoculation for 0.5% of the content.

The sample was washed with ethanol several times, dried and sprayed with 0.4 ml of the inoculant. In order to prevent the drying, the covering film was coated and then cultivated at 95° F., in 90% of relative humidity for 24 hours. After culturing, each sample was extracted to obtain the bacterial extract, diluted properly and measured to elucidate the number of bacteria from the extract (See Table 1).

TABLE 1
(unit: No. of bacteria/ml)

| | Escherichia coil | | | Staphylococcus aureus | | |
|---|---|---|---|---|---|---|
| | No. of | Increase | | No. of | Increase | |
| | Bacteria | ratio | | bacteria | ratio | |
| concentration | 1.4 × 10⁵ | — | | 1.3 × 10⁵ | — | |
| of initial | | | | | | |
| inoculation | | | | | | |
| non-coated | 6.0 × 10⁶ | 43 | times | 6.1 × 10⁶ | 47 | times |
| thermometer | | | | | | |
| 2% coated | <10 | <10⁻⁵ | times | <10 | <10⁻⁵ | times |
| thermometer | | | | | | |
| 4% coated | <10 | <10⁻⁵ | times | <10 | <10⁻⁵ | times |
| thermometer | | | | | | |

As demonstrated in Table 1, the initial numbers of bacteria inoculated were 1.4×10⁵ and 1.3×10⁵ in Escherichia coil ATCC 25922 strain and Staphylococcus aureus ATCC 6538 strain respectively. After 24 hours, in the sample of the thermometer without the titanium dioxide coating, the concentration of each inoculant increased much to reach 43 times and 47 times respectively. On the contrary, the antibacterial thermometer of the present invention coated with titanium dioxide killed almost all the bacteria regardless of the concentration of titanium dioxide and only less than 10 bacteria/ml of bacteria survived.

As a result, the antibacterial thermometer of the present invention was confirmed to have a very high antibacterial activity against microorganisms.

### Industrial Applicability

As demonstrated above, the antibacterial thermometer of the present invention has features to be coated with titanium dioxide (TiO₂) and to inhibit the proliferation of bacteria with its antibacterial activity. In addition, the cooking thermometer of the present invention is advantageous to adjoin foodstuffs directly without hygienic problem. Besides, the titanium dioxide coating layer can be utilized semi-permanently, since it is hard enough and has a function of the photo-catalyst.

Those skilled in the art will appreciate that the conceptions and specific embodiments disclosed in the foregoing description may be readily utilized as a basis for modifying or designing other embodiments for carrying out the same purposes of the present invention. Those skilled in the art will also appreciate that such equivalent embodiments do not depart from the spirit and scope of the invention as set forth in the appended claims.

What is claimed is:

1. An antibacterial thermometer coated with titanium dioxide, which comprises:
a temperature measurement device for calculating and indicating the temperature of foodstuffs during cooking; and, a titanium dioxide coating layer which has an antibacterial activity and covers the surface of said temperature measurement device;
wherein said temperature measurement device comprises:
a heat sensing part containing a liquid expanding the volume in accordance with temperature;
a measuring part which makes one body with said heat sensing part, has a pathway in the inside for moving said liquid and contains graduations corresponding to the expansion of said liquid.

2. The antibacterial thermometer coated with titanium dioxide according to claim 2, in which said thermometer is fixed onto one surface of a base plate; and said base plate comprises:
a cover surrounding said heat sensing part of said thermometer;
temperature graduations indicated through said thermometer;
a handle formed on the upper part; and,
said base plate comprises an elastic clip which can be fixed and inserted to a cooking container in the standing state.

3. The antibacterial thermometer coated with titanium dioxide according to claim 1, in which the surface of said thermometer is composed of materials including aluminum or stainless steel.

4. The antibacterial thermometer coated with titanium dioxide according to claim 2, in which the surface of said thermometer is composed of materials including aluminum or stainless steel.
